(19) United States
(12) Patent Application Publication
(10) Pub. No.: US 2020/0215754 A1
(43) Pub. Date: Jul. 9, 2020

(54) OPTICAL HEAD AND MODELING APPARATUS

(71) Applicant: SONY SEMICONDUCTOR SOLUTIONS CORPORATION, KANAGAWA (JP)

(72) Inventor: HIIZU OOTORII, KANAGAWA (JP)

(21) Appl. No.: 16/627,570

(22) PCT Filed: May 17, 2018
(86) PCT No.: PCT/JP2018/019037

§ 371 Date: Dec. 30, 2019

(30) Foreign Application Priority Data
Jul. 10, 2017 (JP) 2017-134731

(51) Int. Cl. B29C 64/264; G02B 3/00; G02B 27/30; B33Y 30/00

(52) U.S. Cl. CPC B29C 64/264; G02B 3/0062; B33Y 30/00; G02B 3/0087; G02B 27/30

(57) ABSTRACT

An optical head (50) according an embodiment includes a light source unit (20) and a regulator (30). The regulator includes an outer surface (32) including a regulation surface (32a), and an internal space (35) in which the light source unit is arranged, the regulator supporting the light source unit, the regulator regulating a level of a liquid of a material (Q) using the regulation surface, the material being hardened by being irradiated with light by the light source unit.

### TECHNICAL FIELD

The present technology relates to a modeling apparatus that hardens a material by irradiating light onto the material to form a three-dimensional modeling object, and an optical head of the modeling apparatus.

### BACKGROUND ART

The apparatus disclosed in Patent Literature 1 includes, for example, a radiation source, a modulator (an acousto-optical modulator), and deflection means, in which a radiation beam modulated by the modulator is guided to the deflection means. The deflection means includes two galvanometer mirrors, and the galvanometer mirrors cause the radiation beam to enter the surface of a photoformable composition (a photosensitive material) while moving the radiation beam in an X direction and a Y direction. A stage on which a modeling object (a photohardened portion) is formed, is moved down by placement means, so that the photohardened portion is formed layer by layer (disclosed in paragraphs [0019] and [0024] of the specification, and FIG. 1).

The exposure head unit of the modeling apparatus disclosed in Patent Literature 2 includes a cylindrical, transparent, and rotatable drum as a regulation member that regulates the liquid level of a material. An end in an axis direction of the drum is closed, and the other end is opened. The exposure head unit includes an irradiation unit disposed in the drum. The irradiation unit has a shape long along the axial direction of the drum, and includes an LED (light-emitting diode) array one-dimensionally arranged along a longitudinal direction of the drum. In other words, the irradiation unit serves as a line light source. The irradiation unit includes a circuit board including a driver that individually drives each LED included in the LED array (disclosed in, for example, paragraphs [0036], [0037], and [0044] of the specification, and FIG. 2).

### CITATION LIST

### Patent Literature

Patent Literature 1: Japanese Patent Application Laid-open No. 05-237942
Patent Literature 2: Japanese Patent Application Laid-open No. 2015-120261

### DISCLOSURE OF INVENTION

### Technical Problem

In the apparatus disclosed in Patent Literature 1, there is a need to provide, between a light source (a radiation source) and a light-irradiation position, an acousto-optical modulator and a light-scanning mechanism such as two mirrors, the light-irradiation position being a position of the level of a liquid of a material, the two mirrors being mirrors for maintaining the light-irradiation position with a high degree of accuracy. Further, there is a need for a space to provide the modulator and the scanning mechanism, which results in making the apparatus larger.

The exposure head unit disclosed in Patent Literature 2 does not include the scanning mechanism as disclosed in Patent Literature 1. However, there is room for improvement in forming a modeling object with a high degree of precision (at a high resolution).

An object of the present disclosure is to provide a modeling apparatus and an optical head used in the modeling apparatus, the modeling apparatus being capable of forming an exquisite modeling object without including, for example, a scanning mechanism.

### Solution to Problem

In order to achieve the object described above, an optical head according an embodiment includes a light source unit and a regulator.

The regulator includes an outer surface including a regulation surface, and an internal space in which the light source unit is arranged, the regulator supporting the light source unit, the regulator regulating a level of a liquid of a material using the regulation surface, the material being hardened by being irradiated with light by the light source unit.

Since the regulator supports the light source unit in the internal space, the regulator and the light source unit are integrated. This makes it possible to accurately control the light-irradiation position in a material. In other words, a modeling apparatus including the optical head can form an exquisite modeling object without including, for example, a scanning mechanism.

The light source unit may be at least one line light source unit, the line light source unit being provided to be long in a certain direction.

The optical head may further include a displacement mechanism that displaces an irradiation position in a direction orthogonal to the certain direction, the irradiation position being a position in the material at which light emitted by the light source unit is irradiated onto the material. This makes it possible to optimize the light-irradiation position in the material.

The light source unit may include a light source array that includes a plurality of light-emitting elements provided in a staggered arrangement, and a plurality of sub-line light sources arranged in a direction orthogonal to the certain direction, may be formed in the light source array.

The light source unit may be a face light source unit that includes the line light source units arranged in a direction orthogonal to the certain direction. This results in being able to increase a modeling speed.

The regulation surface may include a plurality of grooves each provided between two respective light-transmission regions, each light-transmission region being a region through which light from a corresponding one of the line light source units, is transmitted. The material can flow through the grooves, so the material is easily spread across the entire regulation surface.

The regulator may include at least one supply port and at least one release port for a coolant. The internal space may include a passage through which the coolant flows, the passage communicating with the at least one supply port and the at least one release port.

Accordingly, the thermal expansion of the line light source unit can be suppressed by cooling the line light source unit. The suppression of the thermal expansion makes it possible to suppress a stress or a deformation that is likely to occur in the optical head due to a difference in a coefficient of thermal expansion between the line light source unit and the regulator, even if the difference in a coefficient of thermal expansion is large.

The line light source unit may include a light source array and a circuit board. The light source array includes a plurality of light-emitting elements arranged at least in the certain direction. The circuit board supports the light source array, is provided to be long in the certain direction, and is arranged to face the passage. This makes it possible to cool the circuit board of the line light source unit efficiently.

The regulator may have a first end that is situated in the certain direction and at which the at least one supply port is arranged; and a second end that is situated on a side opposite to the first end in the certain direction, and at which the at least one release port is arranged. This makes it possible to suppress the occurrence of a temperature gradient in the internal space.

The regulator may include a facing surface that faces the regulation surface, and the at least one supply port and the at least one release port may be arranged on the facing surface. Accordingly, the occurrence of a temperature gradient in the internal space is further suppressed.

At least one pair of the supply port and the release port, from among the at least one supply port and the at least one release port that are arranged on the facing surface, may be arranged in a direction different from the certain direction.

The light source unit may include a light source array and a lens unit. The light source array includes a plurality of light-emitting elements arranged at least in the certain direction. The lens unit includes a lens unit provided in a light path from the light source array. This makes it possible to perform an accurate and precise exposure.

The light source unit may be arranged at a position of a center of gravity of the regulator in a vertical direction orthogonal to the certain direction.

The regulator may include a lens region provided in a light path from the light source unit. Since the lens region serves as an objective situated closest to a material, it is possible to set a shortest distance between the objective and the material.

The regulator may be configured to hermetically seal the internal space. This makes it possible to maintain airtightness within the internal space.

The regulator and a modeling tank may be integrated to be provided, the modeling tank containing the material. This makes it possible to make a modeling apparatus smaller.

The modeling tank may include a bottom portion, and the regulator may be provided to the bottom portion.

The optical head may further include at least one of a material nozzle that supplies the material, an ink nozzle that supplies an ink to hardened layers of the material, or a coolant nozzle that supplies a coolant.

In this case, the optical head may further include a support member that integrally supports the regulator and the material nozzle (and/or the ink nozzle), or a support member that integrally supports them and the coolant nozzle.

An optical head according to another embodiment includes the light source unit, the regulator, and a support member that integrally supports the light source unit and the regulator.

Since the light source unit and the regulator are integrally supported by the support member, it is possible to accurately control the light-irradiation position in a material. In other words, a modeling apparatus including the optical head can form an exquisite modeling object without including, for example, a scanning mechanism.

A modeling apparatus according to an embodiment includes a stage, the optical head arrangeable to face the stage, and a movement mechanism.

A modeling object is formed on the stage, the modeling object being made of a material that is hardened by being irradiated with light.

The movement mechanism relatively moves the stage and the optical head.

### Advantageous Effects of Invention

As described above, the present technology makes it possible to form an exquisite modeling object without including, for example, a scanning mechanism.

Note that the effect described here is not necessarily limitative and may be any effect described in the present disclosure.

### BRIEF DESCRIPTION OF DRAWINGS

FIG. 1 illustrates a modeling apparatus according to an embodiment.

FIG. 2 is a cross-sectional view of an optical head, as viewed from an x direction in FIG. 1.

FIG. 3 is a plan view of a light source unit, as viewed from a z direction in FIG. 1.

FIGS. 4A and 4B are plan views of light source units according to other embodiments.

FIGS. 5A to 5C are cross-sectional views of a light source unit according to yet other embodiments.

FIG. 6A is a cross-sectional view of an optical head that includes a light source unit according to yet another embodiment. FIG. 6B is a plan view of the light source unit.

FIG. 7 is a cross-sectional view of an optical head according to another embodiment.

FIG. 8 is a cross-sectional view of an optical head according to yet another embodiment.

FIG. 9 is a cross-sectional view of an optical head according to yet another embodiment.

FIG. 10 is a modification of the optical head illustrated in FIG. 9.

FIG. 11 is a cross-sectional view of an optical head according to yet another embodiment.

FIG. 12 is a modification of the optical head illustrated in FIG. 11.

FIG. 13 is another modification of the optical head illustrated in FIG. 12.

FIG. 14 is yet another modification of the optical head illustrated in FIG. 11.

FIG. 15 is a cross-sectional view of an optical head according to yet another embodiment.

FIG. 16 is a cross-sectional view of an optical head (and a modeling apparatus) according to yet another embodiment.

FIG. 17 is a modification of the optical head (and the modeling apparatus) illustrated in FIG. 16.

FIG. 18 is a modification of the optical head (and the modeling apparatus) illustrated in FIG. 17.

FIG. 19 is a cross-sectional view of an optical head according to yet another embodiment.

FIG. 20 is a modification of the optical head illustrated in FIG. 19.

FIG. 21 is a modification of the optical head illustrated in FIG. 19.

FIG. 22 is a cross-sectional view of an optical head according to yet another embodiment.

FIG. 23 is a modification of the optical head illustrated in FIG. 22.

FIG. 24 is a cross-sectional view of a modeling apparatus according to other embodiments.

FIG. 25 is a modification of the modeling apparatus illustrated in FIG. 24.

FIG. 26 is a modification of the modeling apparatus illustrated in FIG. 25.

### MODE(S) FOR CARRYING OUT THE INVENTION

Embodiments according to the present technology will now be described below with reference to the drawings.

### 1. Modeling Apparatus

### 1.1) Entire Configuration

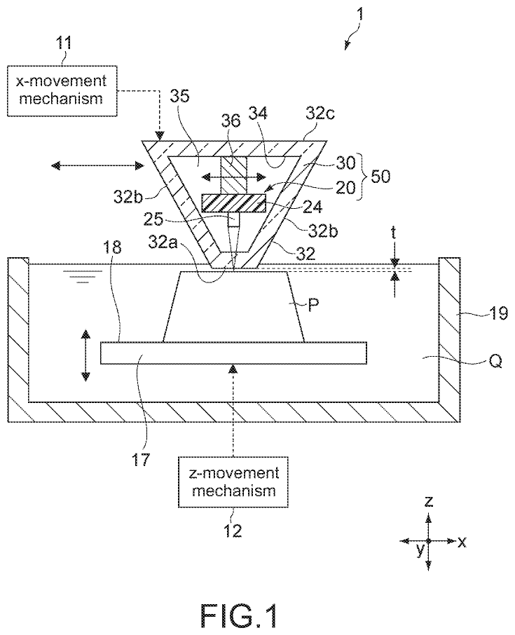

FIG. 1 illustrates a modeling apparatus according to an embodiment. A modeling apparatus 1 includes a stage 17, a modeling tank 19, and an optical head 50.

The modeling tank 19 contains a liquid photohardenable resin Q that is a material for a modeling object P. An upper portion of the modeling tank 19 is opened. The photohardenable resin Q is hereinafter simply referred to as a “material”. The material includes a solvent and a photosensitive material. However, a functional material may be additionally mixed in the material, the functional material adding functionality to an included material itself.

The stage 17 includes a stage surface 18 that is a surface on which a modeling object P is formed. Typically, when modeling is performed, the stage 17 is placed in the modeling tank 19 and dipped in the material Q contained in the modeling tank 19.

The optical head 50 is arrangeable to face the stage surface 18 of the stage 17. The optical head 50 includes a regulator 30 and a light source unit 20.

The regulator 30 includes an outer surface 32 including a regulation surface 32a, and an internal space 35 in which the light source unit 20 is arranged, the regulator 30 supporting the light source unit 20 in the internal space 35. The outer surface 32 includes the regulation surface 32a, for example, four lateral surfaces 32b, and an upper surface 32c. The light source unit 20 is supported by, for example, a support 36 provided on an inner surface 34 (such as a ceiling surface of the internal space 35) of the regulator 30. The regulator 30 includes a function that regulates, using the regulation surface 32a, the level of a liquid of the material Q to form a specified thickness (the thickness of a layer of stacked hardened layers) of the material Q, as illustrated in FIG. 1. This thickness t of a layer of stacked layers, that is, a stacking pitch for each layer is, for example, tens to hundreds of μm.

Note that the position in the regulator 30 at which the support 36 is provided does not necessarily have to be a ceiling surface from among surfaces of the inner surface 34, and it may be an inner lateral surface situated opposite to the lateral surface 32b, or may be other positions. The support 36 may be in the form of a frame.

Glass (such as quartz), acrylic, or any other material transparent to a light source to be used, is used as a primary material of the regulator 30.

The light source unit 20 of the optical head 50 is a line light source unit that is formed to be long in a certain direction (a y direction in FIG. 1), which will be described later. The modeling apparatus 1 includes an x-movement mechanism 11 that moves the optical head 50 in a plane parallel to the stage surface 18 in an x direction orthogonal to the y direction. One hardened layer of a material is formed every time the x-movement mechanism 11 causes the optical head 50 to perform scanning.

Further, the modeling apparatus 1 includes a z-movement mechanism 12 that moves the stage 17 in a z direction that is a vertical direction. The z direction is identical to a direction of stacking hardened layers. A material is exposed to light by the z-movement mechanism 12 causing the stage 17 to go down by the thickness t of a layer of stacked layers every time one hardened layer is formed, which results in stacking hardened layers. Accordingly, the modeling object P, a three-dimensional hardened object of the material, is formed.

A “movement mechanism” includes the x-movement mechanism 11 and the z-movement mechanism 12. In other words, the movement mechanism includes a function that relatively moves the optical head 50 and the stage 17. A known drive mechanism such as ball screw drive, linear motor drive, rack-and-pinion drive, or belt drive, is used as the movement mechanism.

### 1.2) Configuration of Optical Head

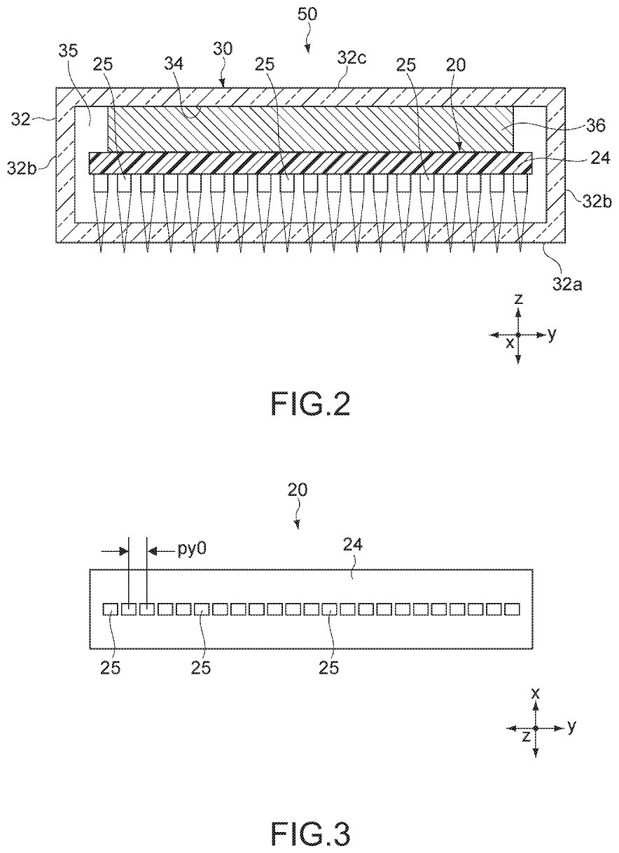

FIG. 2 is a cross-sectional view of the optical head 50, as viewed from the x direction. The regulator 30 is formed to be long in the certain direction (the y direction). As illustrated in FIG. 1, the profile of the regulator 30 has a generally triangular shape, as viewed from the y direction, and the internal space 35 has a shape identical to the shape of the profile of the regulator 30. The regulator 30 is configured to hermetically seal the internal space 35.

The regulation surface 32a from among surfaces of the outer surface 32 of the regulator 30 is formed to be a region sufficiently smaller than the upper surface 32c, and is formed to be long in the y direction. In the present embodiment, as illustrated in FIG. 1, the regulator 30 is arranged such that the regulation surface 32a from among the surfaces of the outer surface 32 of the regulator 30 is situated in a lower portion of the regulator 30 to face the stage 17 (or hardened layers that are the modeling object P).

FIG. 3 is a plan view of the light source unit 20, as viewed from the z direction. As described above, the light source unit 20 includes a light source array including a plurality of light-emitting elements 25 arranged in the y direction. The light source array is supported by a circuit board 24 provided to be long in the y direction, and is electrically connected to the circuit board 24. An LED or a laser diode (LD) is used as the light-emitting element 25. The emission intensities of the light-emitting elements 25 are individually controlled by the circuit board 24.

The light source array includes light-emitting elements each having a size of the order of μm. In fact, the number of light-emitting elements 25 provided is larger than what is illustrated in the figure. For example, about hundreds to thousands of light-emitting elements 25 are provided, or about tens of thousands of light-emitting elements 25 are provided in the case of a large modeling apparatus.

Light emitted by the light source unit 20 is infrared, visible light, or ultraviolet, and is not particularly limited. It is favorable that light of a peak wavelength not greater than 450 nm be used, the wavelength not greater than 450 nm being a wavelength of light used in a photolithographic process upon semiconductor manufacturing. More favorably, the wavelength is from 340 nm to 410 nm.

The support 36 may include a displacement mechanism (not illustrated) that displaces an irradiation position in the x direction, the irradiation position being a position in a material at which light emitted by the light source unit 20 is irradiated onto the material. The irradiation position in a material (a position in the x direction) at which light emitted by the light source unit 20 is irradiated onto the material, is adjusted to an optimal position by the displacement mechanism. The amount by which the irradiation position is displaced by the displacement mechanism is, for example, 10 mm or less, and, favorably, tens of μm to 1 mm.

A translational motion mechanism or a rotational motion mechanism is used as the displacement mechanism. Examples of the translational motion mechanism include a mechanism such as a microdevice and a piezoelectric element. Examples of the rotational motion mechanism include a rotary motor. When a rotational motion mechanism is used, the rotational motion mechanism rotates the light source unit 20 about a rotational axis parallel to the y direction.

For example, depending on the shape of the regulation surface 32a, a material may be accurately hardened and thus it may become easy to remove the hardened layers from the regulation surface 32a, by setting an irradiation position in the material Q to an optimal position in a range of a width of the regulation surface 32a in the x direction. In particular, when exposure is performed in each of a one-way scanning and a return scanning in the x direction, it is favorable that the irradiation position be displaced for each of the scannings. As described above, the setting of an irradiation position to an optimal position makes it possible to perform exquisite modeling and to improve a yield rate.

### 1.3) Effects

In this optical head 50, the regulator 30 supports the light source unit 20 in the internal space 35 of the regulator 30, which results in integrating the regulator 30 and the light source unit 20. This makes it possible to accurately control the light-irradiation position in a material. In other words, since there is no need to provide the scanning mechanism or the modulator disclosed in Patent Literature 1 to the modeling apparatus 1 including the optical head 50, it is possible to form an exquisite modeling object P.

Further, there is no need for a space for arranging the modulator and the scanning mechanism between the light source unit 20 and a material, which results in being able to make the modeling apparatus 1 smaller.

Furthermore, in the apparatus disclosed in Patent Literature 1, there is a need to synchronize all of a mechanical operation of the scanning mechanism (galvanometer mirrors), an operation of the modulator, and an operation of controlling the height of the stage (stage). On the other hand, in the present embodiment, there is no need for a mechanical operation performed by a galvanometer mirror, which results in an easier synchronization control.

Since the regulator 30 has a hermetically sealing configuration, it is possible to maintain airtightness within the internal space 35. For example, no dusts enter a light path from the light source unit 20, which makes it possible to prevent the occurrence of noise. Thus, exquisite modeling is possible.

When the regulator 30 does not have a hermetically sealing configuration, and when an optical member such as a lens is provided in the light path, as described later, condensation occurs on the optical member due to a volatile element of the material Q, and thus a desired amount of light is not obtained. Alternatively, noise may be mixed into light (a signal of light). However, such a problem will be solved by the regulator 30 having a hermetically sealing configuration.

### 2. Light Source Unit According to Other Embodiments

Next, other embodiments are described. In the following descriptions, regarding, for example, the members and the functions included in the modeling apparatus 1 or in the optical head 50 according to the embodiment described above, a substantially similar component is denoted by the same reference symbol, and a description thereof is simplified or omitted. Descriptions are made focused on a point of difference.

### 2.1) Example 1

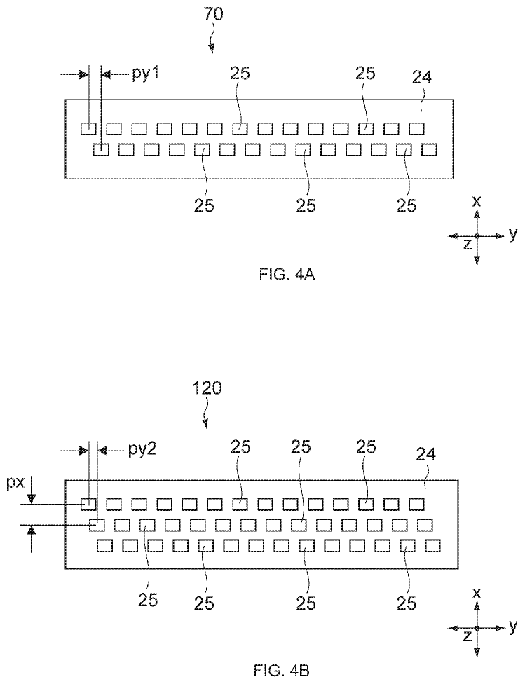

FIG. 4A is a plan view of a light source unit according to another embodiment. This light source unit 70 includes a light source array including a plurality of light-emitting elements 25 provided in a staggered arrangement. In this example, two lines of the arranged light-emitting elements 25 are provided in the x direction. An arrangement pitch py1 of the light-emitting element 25 in the y direction is set smaller than an arrangement pitch py0 of the light-emitting element 25 illustrated in FIG. 3.

### 2.2) Example 2

FIG. 4B is a plan view of a light source unit according to yet another embodiment. In the present embodiment, three lines of the light-emitting elements 25 provided in a staggered arrangement are provided in the x direction. An arrangement pitch py2 of the light-emitting element 25 in the y direction is set smaller than the arrangement pitch py0 of the light-emitting element 25 illustrated in FIG. 3.

In addition to Examples 1, 2, the light source array may include four or more lines of the light source elements provided in a staggered arrangement.

A line light source unit in the y direction is formed in the light source unit 70,120 in a staggered arrangement as in the case of Example 1, 2. For example, the line light source unit includes a plurality of sub-line light sources (three lines in the x direction in FIG. 4B). Light is irradiated onto one line in a material by exposure being performed by the three lines of the sub-line light sources (three times). In other words, exposure is performed on an identical line in a material for three lines (three times) while shifting the optical head by a pitch px in the x direction.

Thus, the light-emitting elements 25 in Example 1, 2 described above are arranged at the pitch py1, py2 smaller than the pitch py0 for the light-emitting elements 25 provided in the one-line arrangement illustrated in FIG. 3, and this makes it possible to make a resolving power for an exposure-target line higher.

In the case of the one-line arrangement illustrated in FIG. 3, a higher resolving power can be achieved if a width of a side of the light-emitting element 25 is made smaller in the y direction, but there are limitations with respect to making the width of a side smaller. Thus, the staggered arrangement makes it possible to virtually make an arrangement pitch smaller, which results in a high resolving power.

### 2.3) Example 3

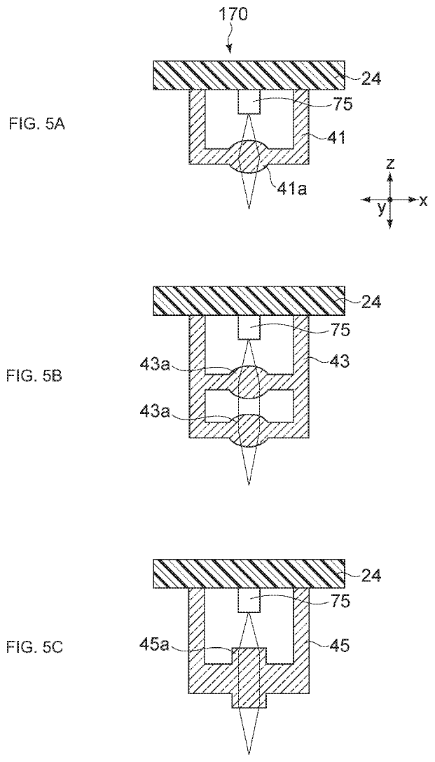

FIG. 5A is a cross-sectional view of a light source unit according to yet another embodiment. The light-emitting element 25 of the light source unit according to each of the embodiments described above is a light-collecting element. A light-emitting element 75 of a light source unit 170 of FIG. 5A is a light-diffusing element. Further, the light source unit 170 includes a lens unit 41 provided in a light path of a light source array including the light-emitting elements 75. The lens unit 41 includes a light-collecting microlens array 41a corresponding to the light source array. This makes it possible to perform an accurate and precise exposure.

### 2.4) Example 4

FIG. 5B illustrates a modification of the light source unit 170 illustrated in FIG. 5A. This lens unit 43 includes a multi-deck such as a double-deck microlens array 43a. The lens unit 43 provides a collimating optical system.

### 2.5) Example 5

FIG. 5C illustrates a light source unit according to another modification. This lens unit 45 includes a gradient-index lens array 45a. Examples of a gradient-index lens include a SELFOC (registered trademark) lens that uses, for example, a rod lens.

The lens unit 41, 43, or 45 may be combined with the light source unit 70, 120 including the light-emitting elements 75 provided in a staggered arrangement, the lens units 41, 43, and 45 being respectively illustrated in FIGS. 5A, 5B, and 5C, the light source units 70 and 120 being respectively illustrated in FIGS. 4A and 4B.

### 2.6) Example 6

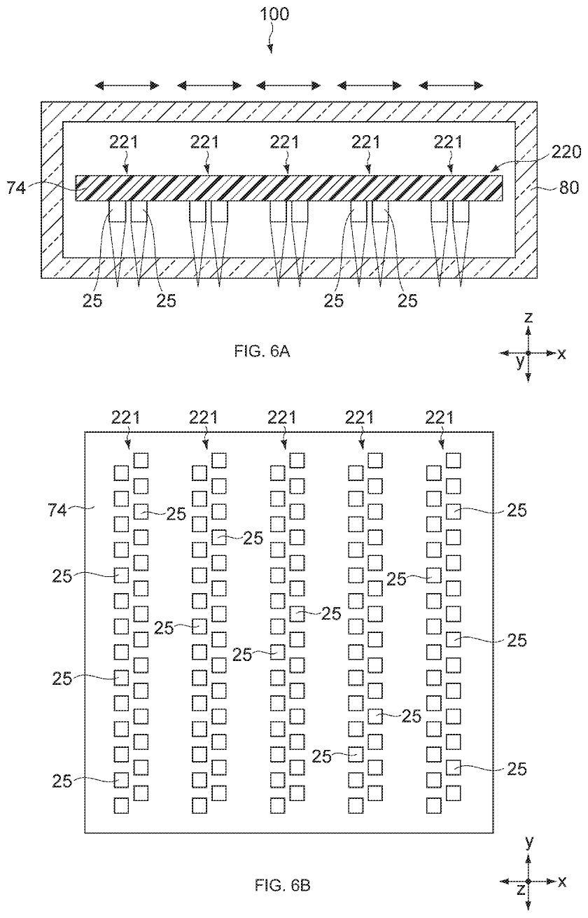

FIG. 6A is a cross-sectional view of an optical head that includes a light source unit according to yet another embodiment. In the following descriptions, an illustration of the support 36 (refer to FIGS. 1 and 2) supporting a light source unit will be omitted unless there is a need to describe the support 36. FIG. 6B is a plan view of a light source unit 220 of an optical head 100 illustrated in FIG. 6A.

The light source unit 220 is a face light source unit that includes a plurality of line light source units 221. For example, the light source unit 220 is formed by a plurality of the line light source units 221 illustrated in FIG. 4A being arranged in a direction (the x direction) orthogonal to a direction (the y direction) of a length of the line light source unit 221. In the figure, for example, five line light source units 221 are provided. Such a light source array forms a face light source. This makes it possible to shorten a scanning distance of the line light source units 221 in the x direction, and enables the respective line light source units 221 to perform exposure at the same time. This results in being able to increase a modeling speed.

Instead of the light source array illustrated in FIGS. 6A and 6B, a light source array formed by a plurality of the line light source units illustrated in FIG. 3 being arranged in the x direction, may be provided as the face light source unit, the line light source unit illustrated in FIG. 3 not being provided in a staggered arrangement but being a one-line line light source unit.

### 3. Optical Head According to Other Embodiments

### 3.1) Example 1

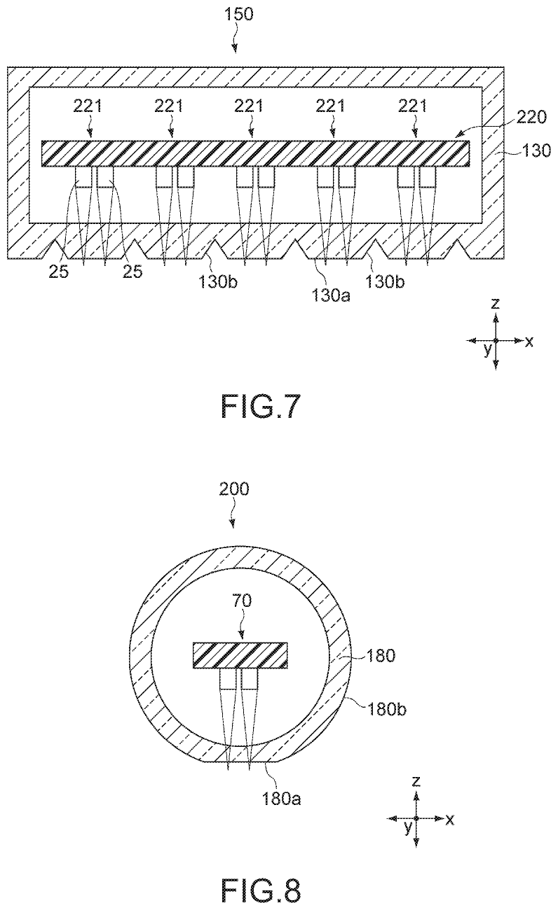

FIG. 7 is a cross-sectional view of an optical head according to another embodiment. This optical head 150 includes the light source unit 220 including the light source array illustrated in FIGS. 6A and 6B. A regulation surface 130a of a regulator 130 includes a plurality of grooves 130b. The grooves 130b are each provided between two respective light-transmission regions in the regulator 130, each light-transmission region being a region through which light from a corresponding one of a plurality of the line light source units 221, is transmitted. It is favorable that the groove 130b be provided to pass through the regulation surface 130a in the y direction.

In the case of the face light source unit including a plurality of line light source units 221 according to the present embodiment, the area of the regulation surface 130a is large. When the regulation surface 130a is large, a material is not easily spread across the entire regulation surface 130a, and this results in a defect easily occurring in a modeling object. When the regulation surface 130a is dipped in a material, the material can flow through the grooves 130b, so the material is easily spread across the entire regulation surface 130a. Further, the light-transmission region does not include the groove 130b, so it is possible to regulate the material with certainty using the regulation surface 130a provided in the light-transmission region situated between the two respective grooves 130b.

### 3.2) Example 2

FIG. 8 is a cross-sectional view of an optical head according to yet another embodiment. In the following descriptions, an optical head that includes the light source unit 70 or 220 is illustrated as an optical head, the light source unit 70 or 220 including a light-emitting array in a staggered arrangement (for example, in two lines) in a line light source unit, as illustrated in FIG. 4 or 6. However, of course, the light source unit 20 including the one-line light-emitting array illustrated in FIG. 3, may also be used in the following descriptions.

A regulator 180 of an optical head 200 according to the present embodiment has a generally cylindrical shape. An outer surface of the regulator 180 includes a plane regulation surface 180a and a cylindrical surface 180b that is a region other than the regulation surface 180a. Such a configuration provides an effect similar to that provided by the modeling apparatus 1 and the optical head 50 described above illustrated in FIG. 1.

The regulation surface does not necessarily have to be plane. The regulation surface may be a portion of the cylindrical surface 180b. In this case, the width of the regulation surface in the x direction is very small, and the regulation surface is macroscopically one-dimensionally formed in the y direction. When the width of the regulation surface is formed to be small, as described above, the area of a hardened material, with which the regulation surface comes into contact, is made small, and this makes it possible to reduce, as much as possible, a stress applied on the regulator from hardened layers when the material is hardened. Consequently, the deformation of the regulator can be suppressed, and thus, exquisite modeling becomes possible.

Further, the area of a hardened material, with which the regulation surface comes into contact, is made small by designing the width of the regulation surface in the x direction as small as possible. This makes it easy to remove the hardened layers from the regulation surface, and chipping or breaking of the hardened layers can be suppressed.

### 3.3) Example 3

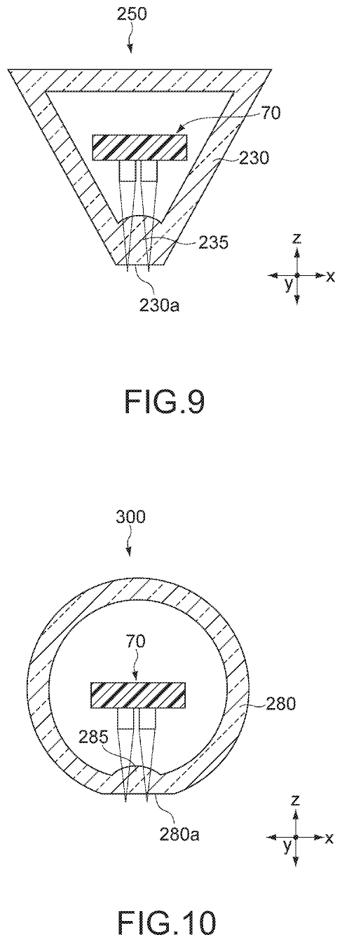

FIG. 9 is a cross-sectional view of an optical head according to yet another embodiment. A regulator 230 of this optical head 250 includes a lens region 235 provided in a light path from the light source unit 70. In other words, the lens region 235 is formed to correspond to a region in which a regulation surface 230a is provided.

Since the lens region 235 serves as an objective situated closest to a material, it is possible to set a shortest distance between the lens region 235 and the material.

Further, for example, collimator coupling can be performed between the light source unit 70 and the regulator 230 (the lens region 235 of the regulator 230) by the light source unit 70 including a collimating optical system. This results in being able to easily determine the positions of the light source unit 70 and the lens region 235 in terms of optical designing.

Furthermore, since the light source unit 70 and the lens region 235 are physically separated (not connected to each other), it is possible to prevent a bad effect due to a difference in a coefficient of thermal expansion between the light source unit 70 and the lens region 235.

### 3.4) Example 4

FIG. 10 is a modification of the optical head illustrated in FIG. 9. An optical head 300 according to the present embodiment includes a regulator 280 that has a generally cylindrical shape. Further, the regulator 280 includes a lens region 285 provided in a light path from the light source unit 70. Such a configuration provides both of the effects according to the embodiments illustrated in FIGS. 8 and 9.

### 3.5) Example 5

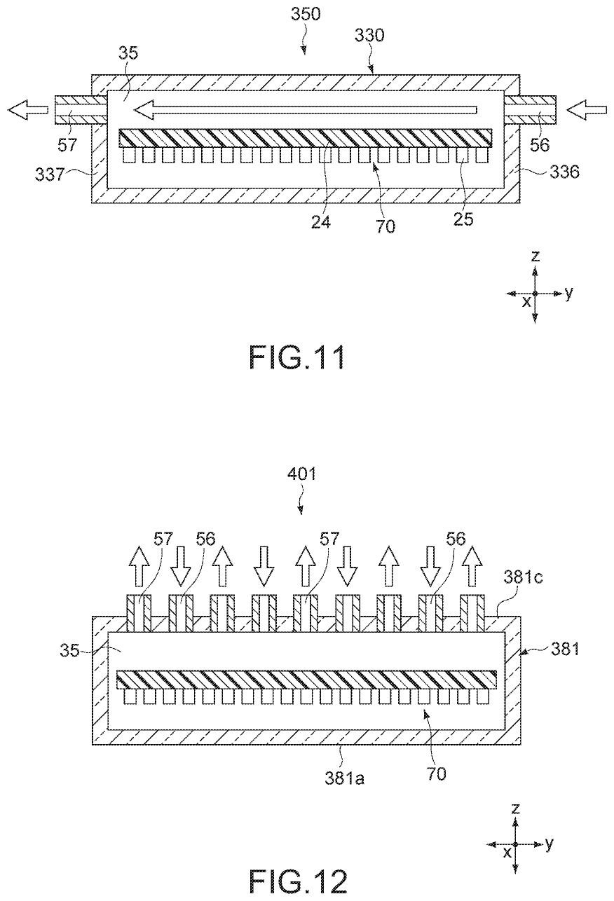

FIG. 11 is a cross-sectional view of an optical head according to yet another embodiment. A regulator 330 of this optical head 350 includes at least one supply port 56 and at least one release port 57 for a coolant. In the present embodiment, one supply port 56 and one release port 57 are provided. The supply port 56 is provided at an end (a first end) 336 of the regulator 330 that is situated in the certain direction (the y direction). The release port 57 is provided at the opposite end (a second end) 337 of the regulator 330. A supply tube and a release tube that are not illustrated are respectively connected to the supply port 56 and the release port 57.

The internal space 35 is configured to communicate with the supply port 56 and the release port 57 so that the coolant flows through the internal space 35. The circuit board 24 of the light source unit 70 is arranged to face a passage of the coolant. Alternatively, the circuit board 24 is provided to form a portion of a wall of the passage in the internal space 35.

For example, air, inert gas, water, or oil is used as the coolant. When liquid is used as the coolant, a tube for liquid is provided as a passage of the coolant in the internal space 35. The temperature of the coolant is appropriately controlled.

For example, it is sufficient if the support 36 illustrated in FIG. 2 also includes a passage through which the coolant flows, although it is not illustrated in FIG. 11. Alternatively, it is sufficient if the support 36 has a passage structure which enables the coolant to flow through the support 36, or is formed in the form of a frame.

Such a configuration makes it possible to suppress the occurrence of a temperature gradient in the internal space 35, and this results in cooling the light source unit (line light source unit) 70 efficiently. Thus, the thermal expansion of the light source unit 70 (in particular, the circuit board 24) can be suppressed. The suppression of the thermal expansion makes it possible to suppress a stress or a deformation that is likely to occur in the optical head 350 (or the warpage of the optical head 350 due to the stress or the deformation) due to a difference in a coefficient of thermal expansion between the circuit board 24 and the regulator 330, even if the difference in a coefficient of thermal expansion is large.

### 3.6) Example 6

FIG. 12 is a modification of the optical head illustrated in FIG. 11. In this optical head 401, at least one supply port 56 and at least one release port 57 are arranged on a facing surface 381c of a regulator 381, the facing surface 381c facing a regulation surface 381a. In the present embodiment, a plurality of supply ports 56 and a plurality of release ports 57 are provided, and the supply port 56 and the release port 57 are alternately arranged in the y direction. Such a configuration further suppresses the occurrence of a temperature gradient in the internal space 35.

### 3.6) Example 6

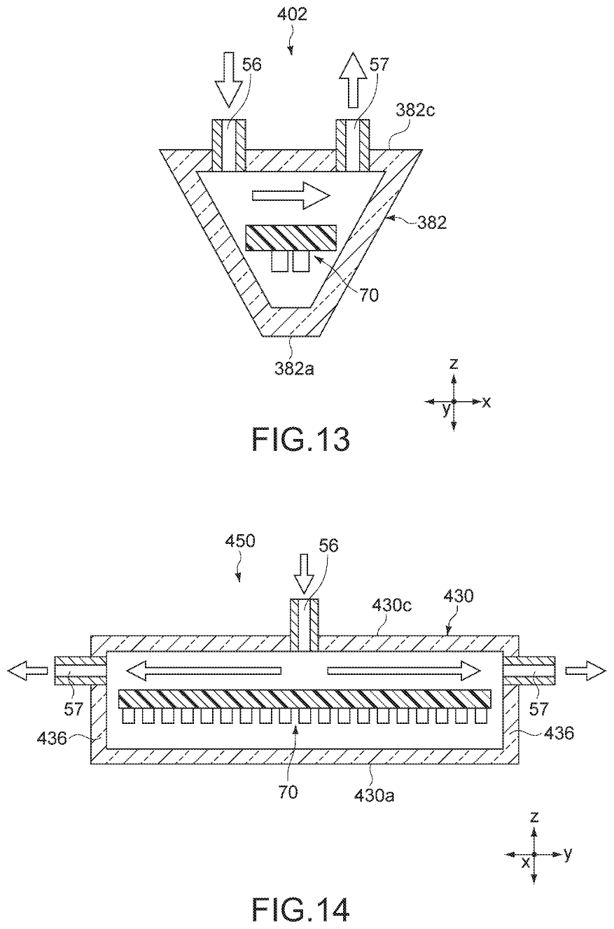

FIG. 13 is another modification of the optical head illustrated in FIG. 12. In this optical head 402, at least one pair of the supply port 56 and the release port 57, from among the supply ports 56 and the release ports 57, is arranged in a direction different from the y direction, that is, in the x direction in this case, the supply port 56 and the release port 57 being arranged on a facing surface 382c of a regulator 382, the facing surface 382c facing a regulation surface 382a of the regulator 382. It is preferable that a plurality of pairs of the supply port 56 and the release port 57 be provided.

The at least one pair of the supply port 56 and the release port 57 is not necessarily limited to being arranged in the x direction, and it may be arranged in an oblique direction that is not identical to the x direction or the y direction.

In FIG. 13, the supply port 56 is arranged on the left, and the release port 57 is arranged on the right. However, when a plurality of pairs of the supply port 56 and the release port 57 is provided, the supply port 56 and the release port 57 may be alternately arranged to be reversed left to right when viewed in each cross section in the x direction, such that the supply port 56 and the release port 57 are alternately arranged in the y direction as illustrated in FIG. 12. In this case, the optical head 401 of FIG. 12 as viewed from the y direction corresponds to an optical head 402 of FIG. 13.

### 3.7) Example 7

FIG. 14 is yet another modification of the optical head illustrated in FIG. 11. In this optical head 450, at least one supply port 56 is arranged on a facing surface 430c of a regulator 430, the facing surface 430c facing a regulation surface 430a of the regulator 430. At least two release ports 57 are respectively arranged at two ends 436 of the regulator 430 that are situated in the y direction.

### 3.8) Example 8

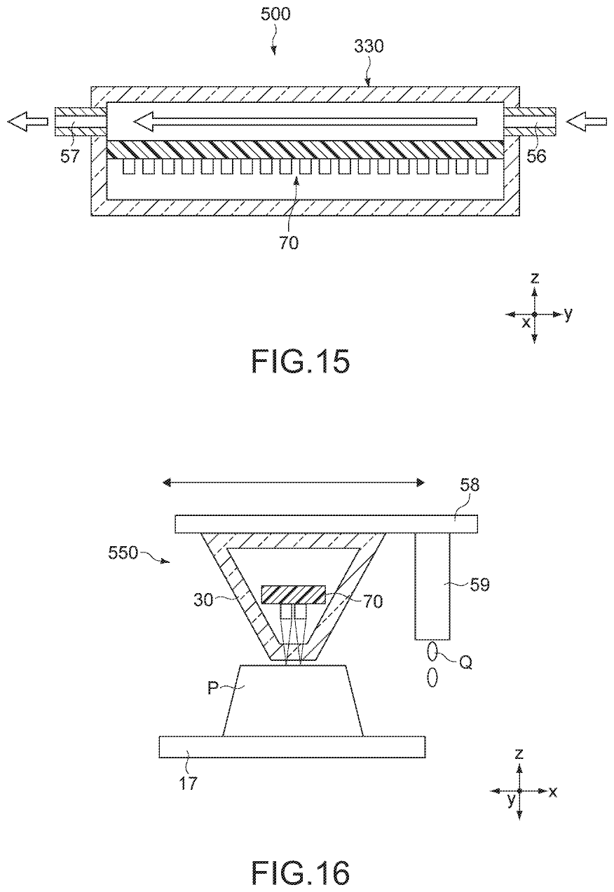

FIG. 15 is a cross-sectional view of an optical head according to yet another embodiment. The light source unit 70 of this optical head 500 is arranged at a position of the center of gravity of the regulator 330 in a vertical direction orthogonal to the y direction, that is, in the z direction. Since the weight of the regulator 330 occupies a large proportion of the weight of the optical head 500, it is sufficient if the light source unit 70 is arranged at the position of the center of gravity of the regulator 330.

Further, in the present embodiment, the circuit board 24 is supported by the two ends of the circuit board 24 in the y direction being connected to an inner surface of the regulator 330. Thus, there is no need for the support 36 (refer to FIG. 2), or it is sufficient if a simple support is provided.

The provision of the light source unit 70 at the position of the center of gravity makes it possible to efficiently suppress a deflection of the optical head 500 due to the difference in a coefficient of thermal expansion described above, even if there is such a difference.

Note that, when the light source unit 70 is provided at the position of a center of gravity as in the present embodiment, a coolant-flowing mechanism (a supply port, a release port, and a passage) does not necessarily have to be provided.

### 3.9) Example 9

FIG. 16 is a cross-sectional view of an optical head (and a modeling apparatus) according to yet another embodiment. This modeling apparatus does not include the modeling tank 19 illustrated in FIG. 1. An optical head 550 includes a material nozzle 59 that supplies a material Q, and a support 58 that integrally supports the regulator 30 and the material nozzle 59. The support 58 can be moved by the x-movement mechanism 11 (refer to FIG. 1) in the x direction.

The material Q is supplied onto the stage 17 (or onto hardened layers of a modeling object P on the stage 17) by the material nozzle 59. Then, the regulator is moved to and stopped at a specified position on the stage 17 by the x-movement mechanism 11, so as to regulate a material to form a thickness of one layer of the material. Then, the light source unit 70 irradiates light onto the material having a thickness of one layer that is obtained by the regulation. Hardened layers are stacked by the operation of supplying a material and performing exposure on the material being repeated for each layer of the material, and this results in forming a modeling object P.

As described above, it is possible to make a modeling apparatus smaller by the modeling apparatus having no modeling tank.

### 3.10) Example 10

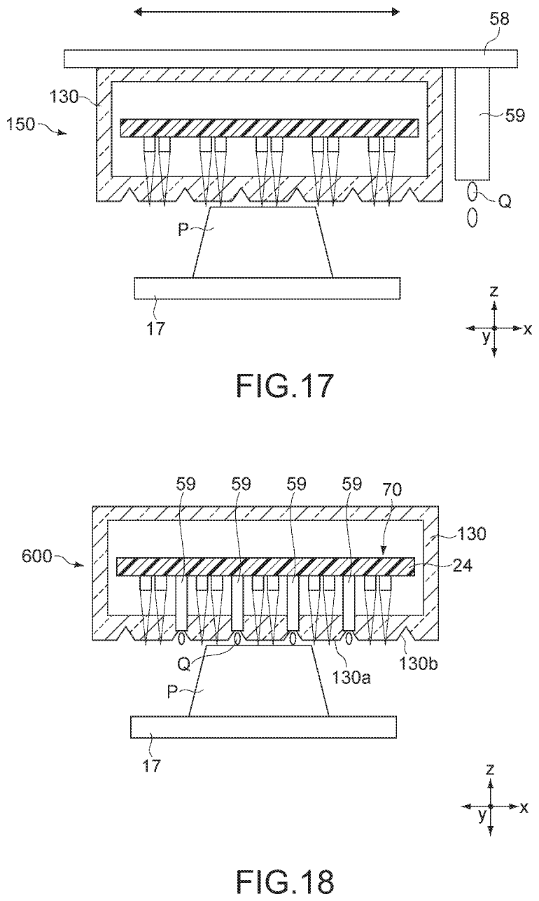

FIG. 17 is a modification of the optical head (and the modeling apparatus) illustrated in FIG. 16. The optical head 150 illustrated in FIG. 7 is used as the optical head according to the present embodiment. In other words, the regulator 130 of the optical head 150 is integrally supported by the support 58 with the material nozzle 59, the regulator 130 including a face light source unit formed by a plurality of the line light source units 221.

In the present embodiment, the optical head 100 illustrated in FIG. 6 may be used instead of the optical head 150 illustrated in FIG. 7.

### 3.11) Example 11

FIG. 18 is a modification of the optical head (and the modeling apparatus) illustrated in FIG. 17. In an optical head 600 according to the present embodiment, the material nozzle 59 is supported by the circuit board 24 of the light source unit 70. The material nozzle 59 may be connected to the circuit board 24 through a connection member (not illustrated) that is fixed to the circuit board 24.

As illustrated in the figure, it is favorable that a plurality of material nozzles 59 be provided to the face light source unit. The material nozzles 59 are arranged in the x direction. The material nozzle 59 is configured and arranged such that a tip of the material nozzle 59 is situated outside the regulator 130. In particular, in the present embodiment, the tip of the material nozzle 59 is situated at the groove 130b provided in the regulation surface 130a. As a result of the tip of the material nozzle 59 being situated at the groove 130b, it becomes possible to facilitate an action of spreading a material across the entire regulation surface 130a (across the entirety of a region, in the regulation surface 130a, that faces a modeling object P).

At least one of the plurality of material nozzles 59 may be replaced with an ink nozzle. The ink nozzle includes a function that discharges a color ink onto hardened layers. For example, the ink nozzle discharges a color ink onto hardened layers for each specified number of layers (one or a plurality of layers) after exposure is performed by the light source unit on the specified numbers of layers. The ink may be a two-color (grayscale) ink or a full-color ink. This enables the modeling apparatus to form a colored modeling object.

### 3.12) Example 12

As yet another modification of the optical heads illustrated in FIGS. 16 to 18, the ink nozzle may be provided instead of, or in addition to the material nozzle(s) 59 described above, although this is not illustrated. In other words, the support 58 integrally supports the regulator and the ink nozzle (and/or the material nozzle(s) 59). In this case, when the material nozzle 59 is not provided, the modeling tank 19 (refer to FIG. 1) is provided.

### 3.13) Example 13

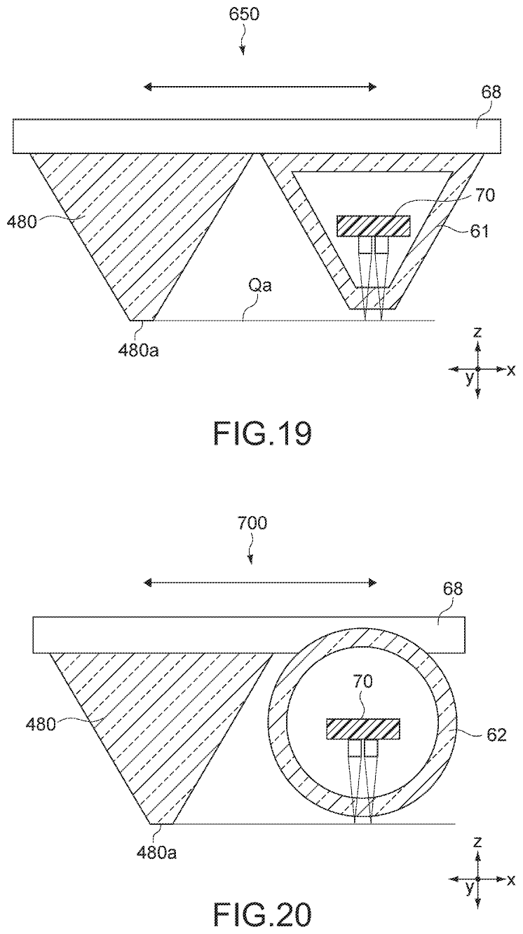

FIG. 19 is a cross-sectional view of an optical head according to yet another embodiment. This optical head 650 includes an accommodation member 61 that accommodates the light source unit 70, a regulator 480, and a support member 68 that integrally supports the accommodation member 61 and the regulator 480. The most distinctive characteristics of the present embodiment are in that a regulation surface 480a of the regulator 480 is not situated in a path of light emitted from the light source unit 70, but away from the light path.

The accommodation member 61 and the regulator 480 are arranged in the x direction orthogonal to the y direction that is the certain direction. The support member 68 can be moved in the x direction by the x-movement mechanism 11 (refer to FIG. 1).

The cross section of the regulator 480 has a generally triangular shape, as viewed from the certain direction, and has the regulation surface 480a in its lower portion. The regulator 480 has a solid structure, but the regulator 480 may have a hollow structure. The regulator 480 may be transparent or non-transparent. The regulator 480 is made of resin or metal.

The accommodation member 61 includes a function that hermetically seals an internal space of the accommodation member 61. Alternatively, the accommodation member 61 may include the lens region 235 as in the case of the regulator 480 illustrated in FIG. 9.

The accommodation member 61 does not necessarily have to be included. In this case, the light source unit 70 is directly supported by the support member 68 or is supported by being connected to the support member 68 through another member.

The optical head 650 is moved by the x-movement mechanism 11. Consequently, the regulation surface 480a evens a material on a stage (or hardened layers) that is not illustrated, and the light source unit 70 follows the movement of the regulator 480 to move and stop at a specified position, and irradiates the evened material with light. The regulation surface 480a serves as a squeegee that runs ahead of the light source unit 70.

According to the present embodiment, the light source unit 70 and the regulator 480 are integrally supported by the support member 68, and this makes it possible to accurately control the light-irradiation position in a material. As a result, an exquisite modeling object is formed.

Note that the height position of the accommodation member 61 may be a position situated close to the light source unit 70 in a direction away from a liquid level Qa of a material (that is, above the regulation surface 480a in the present embodiment), or may be identical to the position of the regulation surface 480a.

### 3.14) Example 14

FIG. 20 is a modification of the optical head illustrated in FIG. 19. In an optical head 700, an accommodation member 62 may have a cylindrical shape, or may be a rectangular parallelepiped although it is not illustrated. The accommodation member 62 may have any shape.

### 3.15) Example 15

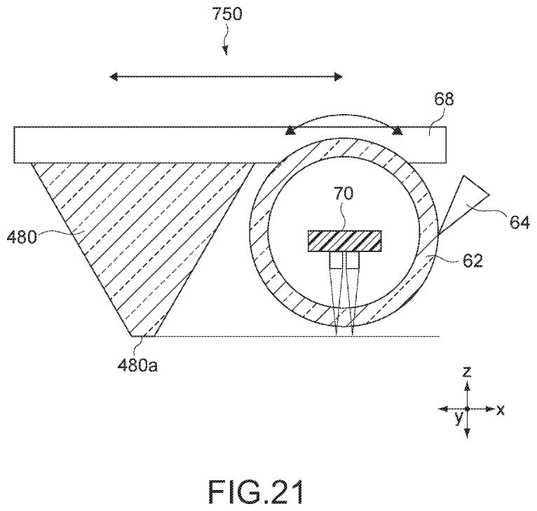

FIG. 21 is a modification of the optical head illustrated in FIG. 19. In an optical head 750 according to the present embodiment, the cylindrical accommodation member 62 is rotatably supported by the support member 68. A modeling apparatus including the optical head 750 includes a cleaning nozzle 64 that supplies cleaning liquid. The cleaning nozzle 64 discharges the cleaning liquid onto the surface of the accommodation member 62 to remove dusts or dirt attached to the surface.

This makes it possible to solve a problem in which, if dirt is attached to the surface of the accommodation member 62, noise will occur when light from the light source unit 70 is transmitted through the accommodation member 62. Since the accommodation member 62 is rotatable, the cleaning nozzle 64 can clean the surface of the accommodation member 62. Further, the cleaning nozzle 64 may include a function such as wiping the dirt off or sucking up the dirt.

### 3.16) Example 16

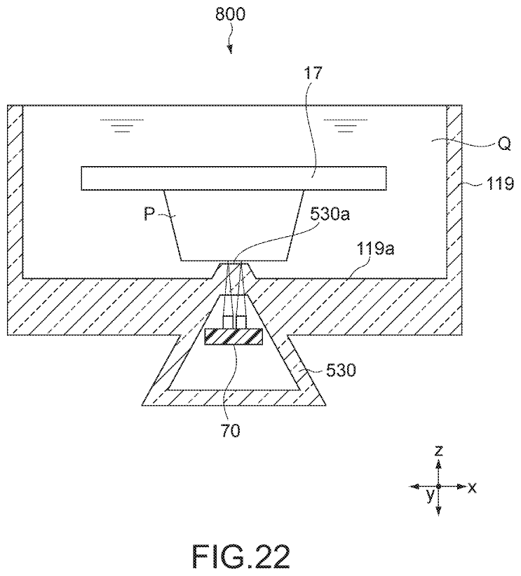

FIG. 22 is a cross-sectional view of an optical head according to yet another embodiment. In an optical head 800 according to the present embodiment, a regulator 530 and a modeling tank 119 are integrated to be provided. The regulator 530 and the modeling tank 119 may be integrated by being integrally molded, or may be integrated by being connected to each other using a connector. This makes it possible to make a modeling apparatus smaller.

In the present embodiment, the regulator 530 is provided to a bottom portion 119a of the modeling tank 119. A regulation surface is arranged in the bottom portion of the modeling tank 119. The regulation surface is situated above the bottom surface, as illustrated in the figure. However, they may be situated at the same height.

As in the case of the embodiment illustrated in FIG. 1, this modeling apparatus includes an x-movement mechanism that moves the regulator in the x direction, and a z-movement mechanism that moves a stage in the z direction.

### 3.17) Example 17

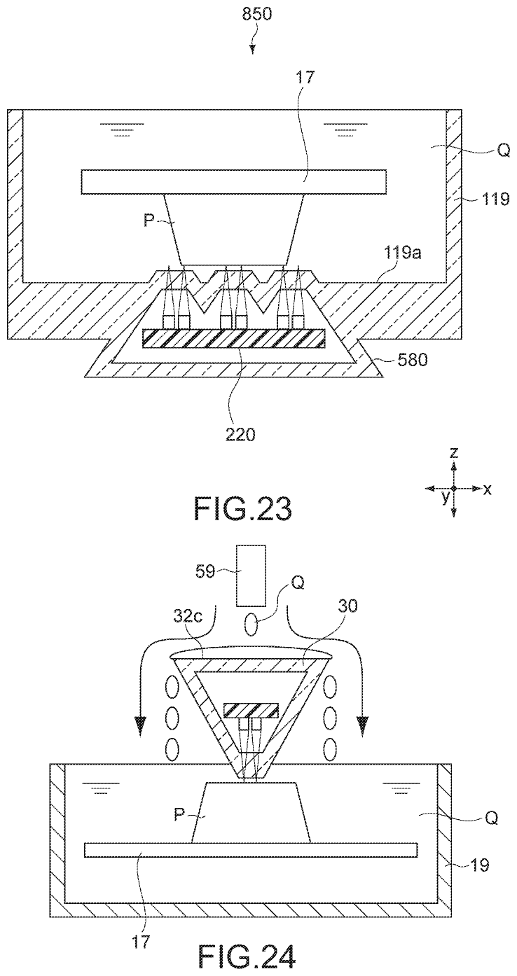

FIG. 23 is a modification of the optical head illustrated in FIG. 22. An optical head 850 according to the present embodiment includes the light source unit 220 that is a face light source unit, and a regulator 580 that accommodates the light source unit 220. The regulator 580 and the modeling tank 119 are integrated to be provided.

### 4. Modeling Apparatus According to Other Embodiments

### 4.1) Example 1

FIG. 24 is a cross-sectional view of a modeling apparatus according to other embodiments. The modeling apparatus according to the present embodiment includes a material nozzle 91 that supplies a photohardenable resin material Q. The material Q serves as a coolant whose temperature is controlled to be a specified temperature. The material nozzle 91 is arranged, for example, above the regulator 30, and the material Q is discharged downward through the nozzle. The material Q flows down the outer surface of the regulator 30, and, in particular, the upper surface 32c of the regulator 30. In other words, the material Q flows to cover the regulator 30. This makes it possible to suppress the warpage of the optical head, as in the case of the embodiment illustrated in, for example, FIG. 11.

### 4.2) Example 2

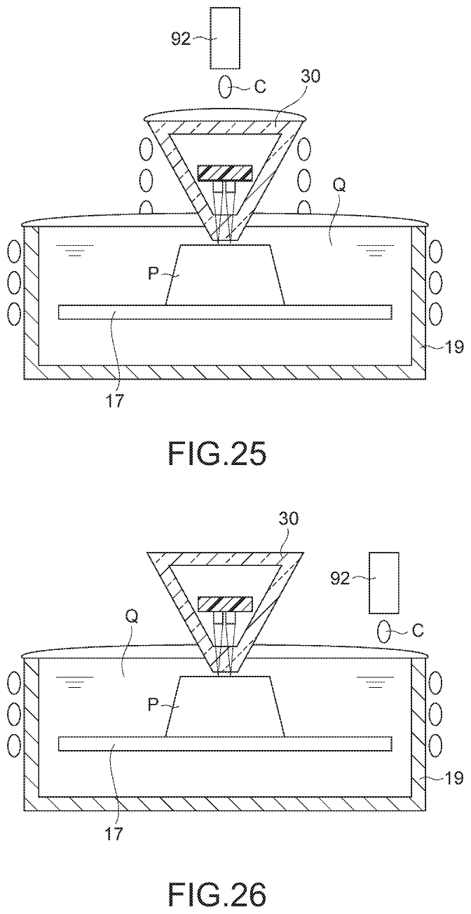

FIG. 25 is a modification of the modeling apparatus illustrated in FIG. 24. Instead of the material nozzle 91, this modeling apparatus includes a coolant nozzle 92 that supplies a coolant. The coolant may be gas or liquid. In the case of liquid, a liquid is used that has a lower specific gravity than a material Q in the modeling tank 19. A coolant C discharged from the coolant nozzle 92 covers the regulator 30, and is also spread over the level of a liquid of the material Q. Accordingly, not only a fluctuation in temperature of the optical head, but also a fluctuation in temperature of the material Q due to light irradiation is suppressed, which results in contributing toward obtaining an exquisite modeling object.

### 4.3) Example 3

FIG. 26 is a modification of the modeling apparatus illustrated in FIG. 25. In this modeling apparatus, the coolant nozzle 92 is arranged above the modeling tank 19, not above the regulator 30. The coolant discharged from the coolant nozzle 92 is spread over the level of a liquid of the material Q, and the material Q is cooled.

### 4.4) Example 4

As yet another modification, the modeling apparatus may include a flow passage through which a coolant discharged from the coolant nozzle 92 flows. In this case, the flow passage may be formed in the regulator 30, and, for example, the flow passage may be formed in the cross section of a member of the regulator 30 illustrated in FIGS. 24 and 25.

### 5. Modifications

The present technology is not limited to the embodiments described above, and may achieve other various embodiments.

In the respective embodiments described above, instead of the x-movement mechanism 11 moving an optical head in the x direction, the movement mechanism for the stage 17 may be configured to move the stage 17 not only in the z direction but also in the x direction. Conversely, the movement mechanism for the optical head may be configured to move not only in x direction but also in the z direction.

Primarily, the light source units described above are a line light source unit or a face light source unit. However, the light source of an optical head may be a point light source. In this case, the optical head includes a mechanism in an internal space of a regulator, the mechanism moving the point light source in a certain direction (for example, the y direction that is a longitudinal direction of the regulator in FIG. 1).

Moreover, at least two of the features of the embodiments described above can also be combined.

For example, in the modeling apparatus illustrated in FIG. 1, a regulator and a modeling tank are integrated to be provided, as in the case of the embodiment illustrated in FIG. 22.

Further, the embodiment using a coolant as illustrated in FIGS. 24 to 26, and at least one of the embodiments illustrated in FIGS. 1 to 23 may be combined.

Furthermore, the cleaning nozzle 64 illustrated in FIG. 21 is applicable to the regulators in the respective embodiments other than the embodiment illustrated in FIG. 21. In this case, for example, it is sufficient if the cleaning nozzle 64 is configured to supply cleaning liquid especially onto the regulation surface.

Note that the present technology may also take the following configurations.

(1) An optical head including:

a light source unit; and

a regulator that includes an outer surface including a regulation surface, and an internal space in which the light source unit is arranged, the regulator supporting the light source unit, the regulator regulating a level of a liquid of a material using the regulation surface, the material being hardened by being irradiated with light by the light source unit.

(2) The optical head according to (1), in which

the light source unit is at least one line light source unit, the line light source unit being provided to be long in a certain direction.

(3) The optical head according to (2), further including a displacement mechanism that displaces an irradiation position in a direction orthogonal to the certain direction, the irradiation position being a position in the material at which light emitted by the light source unit is irradiated onto the material.
(4) The optical head according to (2) or (3), in which

the light source unit includes a light source array that includes a plurality of light-emitting elements provided in a staggered arrangement, and

a plurality of sub-line light sources arranged in a direction orthogonal to the certain direction, is formed in the light source array.

(5) The optical head according to any one of (2) to (4), in which

the light source unit is a face light source unit that includes the line light source units arranged in a direction orthogonal to the certain direction.

(6) The optical head according to (5), in which

the regulation surface includes a plurality of grooves each provided between two respective light-transmission regions, each light-transmission region being a region through which light from a corresponding one of the line light source units, is transmitted.

(7) The optical head according to according to any one of (2) to (6), in which

the regulator includes at least one supply port and at least one release port for a coolant, and

the internal space includes a passage through which the coolant flows, the passage communicating with the at least one supply port and the at least one release port.

(8) The optical head according to (7), in which

the line light source unit includes
a light source array that includes a plurality of light-emitting elements arranged at least in the certain direction, and
a circuit board that supports the light source array, is provided to be long in the certain direction, and is arranged to face the passage.
   (9) The optical head according to (7) or (8), in which

the regulator has
a first end that is situated in the certain direction and at which the at least one supply port is arranged, and
a second end that is situated on a side opposite to the first end in the certain direction, and at which the at least one release port is arranged.
   (10) The optical head according to (7) or (8), in which

the regulator includes a facing surface that faces the regulation surface, and

the at least one supply port and the at least one release port are arranged on the facing surface.

(11) The optical head according to (10), in which

at least one pair of the supply port and the release port, from among the at least one supply port and the at least one release port that are arranged on the facing surface, is arranged in a direction different from the certain direction.

(12) The optical head according to any one of (2) to (11), in which

the light source unit includes
a light source array that includes a plurality of light-emitting elements arranged at least in the certain direction, and
a lens unit provided in a light path from the light source array.
   (13) The optical head according to any one of (2) to (12), in which

the light source unit is arranged at a position of a center of gravity of the regulator in a vertical direction orthogonal to the certain direction.

(14) The optical head according to any one of (1) to (13), in which

the regulator includes a lens region provided in a light path from the light source unit.

(15) The optical head according to any one of (1) to (14), in which

the regulator is configured to hermetically seal the internal space.

(16) The optical head according to any one of (1) to (15), in which

the regulator and a modeling tank are integrated to be provided, the modeling tank containing the material.

(17) The optical head according to (16), in which

the modeling tank includes a bottom portion, and

the regulator is provided to the bottom portion.

(18) The optical head according to any one of (1) to (17), further including at least one of a material nozzle that supplies the material, an ink nozzle that supplies an ink to hardened layers of the material, or a coolant nozzle that supplies a coolant.
(19) An optical head including:

a light source unit;

a regulator that includes an outer surface including a regulation surface, the regulator regulating a level of a liquid of a material using the regulation surface, the material being hardened by being irradiated with light by the light source unit; and

a support member that integrally supports the light source unit and the regulator.

(20) A modeling apparatus including:

a stage on which a modeling object is formed, the modeling object being made of a material that is hardened by being irradiated with light;

an optical head arrangeable to face the stage; and

a movement mechanism that relatively moves the stage and the optical head, in which

the optical head includes
a light source unit that irradiates the light, and
a regulator that includes an outer surface including a regulation surface, and an internal space in which the light source unit is arranged, the regulator supporting the light source unit, the regulator regulating a level of a liquid of the material using the regulation surface.

### REFERENCE SIGNS LIST

1 modeling apparatus
11 x-movement mechanism
12 z-movement mechanism
17 stage
19, 119 modeling tank
20, 70, 170, 220 light source unit
24 circuit board
25, 75 light-emitting element
30, 80, 130, 180, 230, 280, 330, 381, 382, 430, 480, 530, 580 regulator
32 outer surface
32a, 130a, 180a, 230a, 381a, 382a, 430a, 480a regulation surface
32b lateral surface
32c upper surface
35 internal space
41, 43, 45 lens unit
50, 100, 150, 200, 250, 300, 350, 401, 402, 450, 500, 550, 600, 650, 700, 750, 800, 850 optical head
56 supply port
57 release port
59 material nozzle
61, 62 accommodation member
64 cleaning nozzle
68 support member
70, 120, 170, 220 light source unit
92 coolant nozzle
221 line light source unit
235 lens region

1. An optical head comprising:
a light source unit; and
a regulator that includes an outer surface including a regulation surface, and an internal space in which the light source unit is arranged, the regulator supporting the light source unit, the regulator regulating a level of a liquid of a material using the regulation surface, the material being hardened by being irradiated with light by the light source unit.

2. The optical head according to claim 1, wherein
the light source unit is at least one line light source unit, the line light source unit being provided to be long in a certain direction.

3. The optical head according to claim 2, further comprising a displacement mechanism that displaces an irradiation position in a direction orthogonal to the certain direction, the irradiation position being a position in the material at which light emitted by the light source unit is irradiated onto the material.

4. The optical head according to claim 2, wherein
the light source unit includes a light source array that includes a plurality of light-emitting elements provided in a staggered arrangement, and
a plurality of sub-line light sources arranged in a direction orthogonal to the certain direction, is formed in the light source array.

5. The optical head according to claim 2, wherein
the light source unit is a face light source unit that includes the line light source units arranged in a direction orthogonal to the certain direction.

6. The optical head according to claim 5, wherein
the regulation surface includes a plurality of grooves each provided between two respective light-transmission regions, each light-transmission region being a region through which light from a corresponding one of the line light source units, is transmitted.

7. The optical head according to claim 2, wherein
the regulator includes at least one supply port and at least one release port for a coolant, and
the internal space includes a passage through which the coolant flows, the passage communicating with the at least one supply port and the at least one release port.

8. The optical head according to claim 7, wherein
the line light source unit includes
a light source array that includes a plurality of light-emitting elements arranged at least in the certain direction, and
a circuit board that supports the light source array, is provided to be long in the certain direction, and is arranged to face the passage.

9. The optical head according to claim 7, wherein
the regulator has
a first end that is situated in the certain direction and at which the at least one supply port is arranged, and
a second end that is situated on a side opposite to the first end in the certain direction, and at which the at least one release port is arranged.

10. The optical head according to claim 7, wherein
the regulator includes a facing surface that faces the regulation surface, and
the at least one supply port and the at least one release port are arranged on the facing surface.

11. The optical head according to claim 10, wherein
at least one pair of the supply port and the release port, from among the at least one supply port and the at least one release port that are arranged on the facing surface, is arranged in a direction different from the certain direction.

12. The optical head according to claim 2, wherein
the light source unit includes
a light source array that includes a plurality of light-emitting elements arranged at least in the certain direction, and
a lens unit provided in a light path from the light source array.

13. The optical head according to claim 2, wherein
the light source unit is arranged at a position of a center of gravity of the regulator in a vertical direction orthogonal to the certain direction.

14. The optical head according to claim 1, wherein
the regulator includes a lens region provided in a light path from the light source unit.

15. The optical head according to claim 1, wherein
the regulator is configured to hermetically seal the internal space.

16. The optical head according to claim 1, wherein
the regulator and a modeling tank are integrated to be provided, the modeling tank containing the material.

17. The optical head according to claim 16, wherein
the modeling tank includes a bottom portion, and
the regulator is provided to the bottom portion.

18. The optical head according to claim 1, further comprising at least one of a material nozzle that supplies the material, an ink nozzle that supplies an ink to hardened layers of the material, or a coolant nozzle that supplies a coolant.

19. An optical head comprising:
a light source unit;
a regulator that includes an outer surface including a regulation surface, the regulator regulating a level of a liquid of a material using the regulation surface, the material being hardened by being irradiated with light by the light source unit; and
a support member that integrally supports the light source unit and the regulator.

20. A modeling apparatus comprising:
a stage on which a modeling object is formed, the modeling object being made of a material that is hardened by being irradiated with light;
an optical head arrangeable to face the stage; and
a movement mechanism that relatively moves the stage and the optical head, wherein
the optical head includes
a light source unit that irradiates the light, and
a regulator that includes an outer surface including a regulation surface, and an internal space in which the light source unit is arranged, the regulator supporting the light source unit, the regulator regulating a level of a liquid of the material using the regulation surface.
